(19) United States
(12) Patent Application Publication
(10) Pub. No.: US 2003/0024604 A1
(43) Pub. Date: Feb. 6, 2003

(54) Portable work bench with an extension assembly having a workpiece support assembly and work stop assembly thereon

(76) Inventor: Thomas E. Derecktor, Portsmounth, RI (US)

Correspondence Address: Dike, Bronstein, Roberts & Cushman, Intellectual Property Practice Group, EDWARDS & ANGELL, LLP, P.O. Box 9169, Boston, MA, 02209, US

(21) Appl. No.: 09/921,269

(22) Filed: Aug. 2, 2001

(51) Int. Cl. B25H 1/00

(52) U.S. Cl. 144/286.5

(57) ABSTRACT

A portable work bench useful when working in confined working areas, having a track with an elongate, tubular body is disclosed. The track is supported in an elevated position by a support means. Moreover, one or more legs of the support means can include an extendable leg for use on uneven surfaces. Further, a plurality of rail members are configured and arranged on and the track, generally extending along the entire length of the track. A first sliding lock assembly comprising a sliding lock member releasably attached and slidably mounted on one or more of the rail members is provided for mounting an accessory, e.g., a power tool, thereon. A second sliding lock assembly comprising an extension assembly releasably attached and slidably mounted on one of the rail members is provided for mounting an extendable member that includes a work stop assembly and an adjustable work piece support assembly. In a preferred embodiment, the extendable member includes inner and outer concentric members that are telescopingly movable and a cam-type locking device for securely and releasably attaching the outer concentric member to the inner concentric member.

### BACKGROUND OF THE INVENTION

1. Field of the Invention

The present invention relates generally to portable work benches. More particularly, the present invention relates to an improved portable work bench for use in areas of confined space, the work bench having an extension assembly, wherein the extension assembly comprises a work piece support and a work stop assembly, which are disposed on a common extendable member.

2. Background Art

The present invention is directed primarily to an improvement to portable workbenches to Derecktor (U.S. Pat. No. 5,592,981) (the “'981 Invention”) and Derecktor (U.S. Pat. No. 5,836,365) (the “'365 Invention”). The '981 invention discloses a portable work bench comprising a track having an elongate tubular body to which one or more rail members are integrally attached and support means, which is embodied as four retractable legs, for supporting the track in an elevated position above a surface. The '981 invention further and most notably comprises a sliding lock assembly for releasably and adjustably attaching accessories, e.g., a router, power drill, miter saw, and the like, to the work bench. Indeed, a plurality of rail members is integrally attached to the upper, or top, side of the tubular body of the track. One or more sliding lock members, which are components of the sliding lock assembly, are releasably and moveably attached to the plurality of rail members. Accordingly, the sliding lock assembly of the '981 invention facilitates disposing and attaching accessories at any desired location along the length of the track. Furthermore, the '981 invention includes other accessories for adjustably supporting work pieces, e.g., a piece of lumber, at the proper working level and for providing work stops for work pieces. Like the sliding lock assembly, these other accessories are slidably mounted and releasably attached to a rail element on the track so that they, too, are movable and positionable at any location on the rail element.

The '365 invention discloses improvements to the '981 invention. For example, one improvement comprises the inclusion of a tape-measuring device. A second improvement comprises an improved support means. A third improvement comprises a versatile, dual-purpose work support/stop assembly that can be used to support a work piece or to engage one end of the work piece for precise cutting.

Patents to others for portable work benches include the reissued patent to Estrem (U.S. Reissue Pat. No. RE 35,627). The Estrem patent discloses a portable support platform for work pieces, the platform comprising a tool supporting platform, and a left and a right support arm, which are attached to the platform by a support arm bracket means. In one embodiment of the Estrem patent, the left support arm is telescopingly engaged with the right support arm. In a second embodiment, the left and right support arms can be permanently fixed in an extended position. In both embodiments, end supports, which can support a work piece at the level of the power tool work surface as well as hold the work piece in a fixed spatial relationship relative to the power tool, can be disposed at the ends of the left and right support arms.

Problems with the Estrem patent include (i) a requirement for an independent support system, and (ii) the fixedness of the power tool platform. Indeed, the power tool platform is disposed on a slide bracket, which must be attached to, e.g., a sawhorse, to raise the work platform above the surface to a comfortable working level. Hence, the Estrem patent does not have an integral means of support. Moreover, the left and right support arms are cantilevered about a work support bracket and disposed at opposing ends of the work bench on opposing sides of the power tool platform, which remains fixed. As a result, the cantilevered nature of the support arms limits the length and weight of work pieces that a builder or craftsman can use safely or effectively. The longer the cantilever, the greater the vertical deflection at the end of the cantilevered support arm(s). Accordingly, such support arms require greater stiffness, which makes them more expensive.

The patent to Pedri (U.S. Pat. No. 5,526,856) discloses a similar device for supporting a work piece. Indeed, the Pedri patent discloses a central member having telescoping extensions. A pair of L-shaped stops, which can be adjusted vertically, are disposed at the ends of the extensions to (i) support the work piece at the elevation of the power tool and (ii) position work pieces uniformly so that each work piece is positioned in the same position relative to the power tool. As with the Estrem patent, the Pedri device supports only the work piece and not the work piece and the power tool. Furthermore, the central member of the Pedri invention is secured, e.g., by a vise to a sawhorse, and the telescoping extensions are extended, i.e., cantilevered. Indeed, vertical legs expressly are not required to support the cantilevered extensions. However, as with the Estrem patent, the Pedri patent limits the length and weight of work pieces before excessive deflection of the cantilevered extensions ensues or, alternately, requires a stiffer, more expensive extension.

### SUMMARY OF THE INVENTION

Accordingly, among the many objects of the present invention are an improved, more compact portable work bench having sliding connections for adjustably attaching one or more accessories, e.g., a power tool mounting platform and a work stop/work support extension assembly, to the work bench that is better suited for home use or for use in confined spaces. Moreover, a work bench according to the present invention is lightweight, easy to manufacture, but of sturdy design and durable.

The present invention produces a portable work bench comprising a track having an elongate, tubular body. At least one rail member, and preferably three rail members, is integrally attached to and configured and arranged to extend along the length of the tubular body. Indeed, a first and second rail member, which members typically are substantially rectangular in cross-section, are configured and arranged on the upper, or top, side of the tubular body. A third rail member, which also has a substantially rectangular cross-section, is configured and arranged to one side of the tubular body.

The work bench further comprises a supporting means for supporting the track in an elevated position above a surface, e.g., ground surface or shop floor. Indeed, two pair of support legs for disposing the track at a desired elevation about the surface are rotatably attached at either end of the track so that the track is substantially simply supported at both ends, providing only a minimal cantilevered section beyond the simple supports. In yet another embodiment of the present, one or more of the legs can include a telescoping leg extension assembly to facilitate leveling the work bench on uneven surfaces.

Further, one or more sliding lock assemblies are releasably and slidably attached to one or more of the rail members. Each sliding lock assembly comprises a sliding lock member for mounting an accessory thereon and one or more slidable locking means for securely and releasably attaching the sliding lock member at any desired location on the track. Indeed, one sliding lock assembly includes a platform suitably adapted to support and fixedly restrain a power tool, e.g., power saw, power drill, router, etc. This sliding lock assembly is equipped further with means for locking the platform on one or more rail members, which are disposed on the top of the track. A second sliding lock assembly includes an extension assembly comprising an extendable member, having a work piece support assembly and a work stop assembly configured and arranged thereon, and means for releasably and slidably attaching the extendable member to a rail member and/or the support assembly to the extendable member. In yet another embodiment of the present invention, a third sliding lock assembly includes a second extension assembly comprising an extendable member, having a second work piece support assembly configured and arranged thereon, and means for releasably and slidably attaching the extendable member to a rail member and/or the support assembly to the extendable member.

### BRIEF DESCRIPTION OF THE DRAWINGS

The invention will be better understood by referring to the following more detailed description and the accompanying drawings in which like numbered elements refer to like numbered elements:

FIG. 1 is a view of a prior art work bench in accordance with U.S. Pat. No. 5,592,981;

FIG. 2 is a view of a prior art work bench in accordance with U.S. Pat. No. 5,836,365;

FIG. 3a is a perspective view of an illustrative embodiment of one aspect of the portable work bench in accordance with the present invention;

FIG. 3b is an illustrative embodiment of one aspect of an extendable support leg in accordance with the present invention;

FIG. 4 is a cross-sectional view of an illustrative embodiment of one aspect of the track and supporting means of the present invention taken along section 4-4 in FIG. 3;

FIG. 5 is an isometric view of an illustrative embodiment of the extension assembly; and

FIG. 6 is a cross-sectional view of an illustrative embodiment of a sliding lock assembly for the extendable member.

### DETAILED DESCRIPTION OF THE INVENTION AND PREFERRED EMBODIMENTS THEREOF

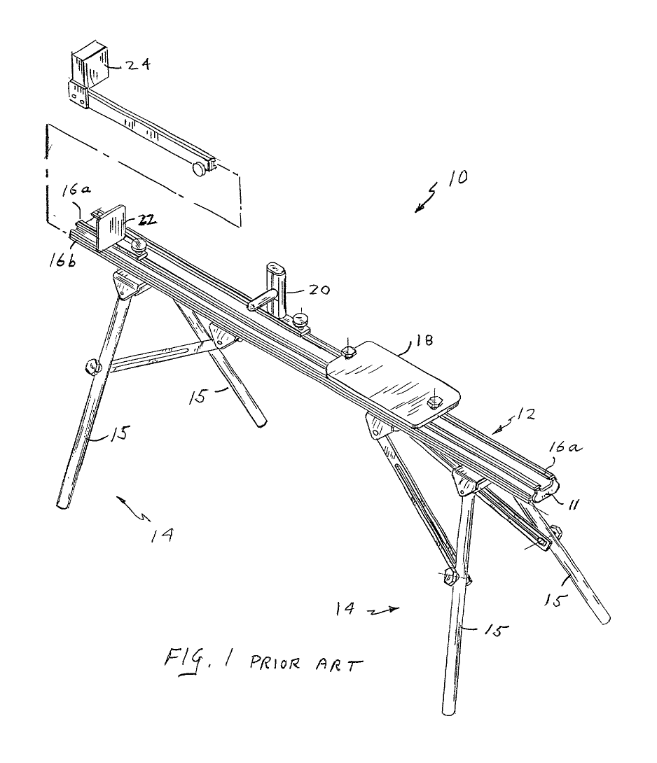

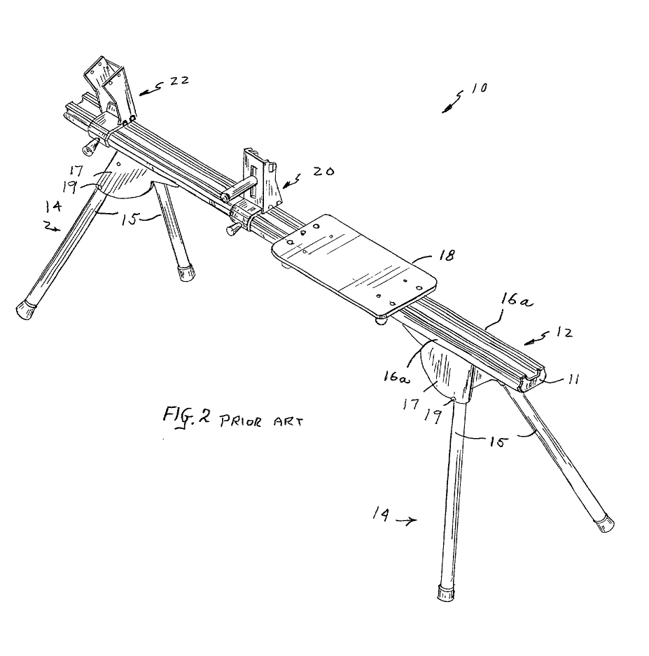

Referring to FIGS. 1 and 2, there are shown embodiments of portable work benches 10 in accordance with the aforementioned '981 patent and '365 patent, respectively, which patents are incorporated herein by reference. Each figure generally shows a work bench 10 comprising an elevated track 12, having a plurality of rail members 16a and 16b integral thereto and configured and arranged for mounting accessories, and support means 14 to elevate and stabilize the track 12 above a surface, e.g., shop floor or ground surface. Furthermore, the prior art work benches 10 include a plurality of releasably attachable accessories, which, for example, can include a movable mounting platform 18 that can be used for mounting a power tool such as a power saw, miter saw, power drill, router, and the like; a movable, adjustable work support assembly 20 for raising, lowering, and supporting a work piece to the working level of the power tool attached to the support platform 18, and a movable work stop assembly 22, for engaging one end of a work piece at any desired length, e.g., for establishing a cut length and the like. The work bench 10 shown in FIG. 1 includes, further, an optional work stop extension assembly 24.

The track 12 is an elongate, structural tubular body 11, to which a number of rail members 16a and 16b is integrally formed. Two rail members 16a are shown in FIG. 2 and three rail members 16a and 16b are shown in FIG. 1. The rail members 16a and 16b are suitable as sliding connections for releasably and adjustably attaching one or more accessories to the track 12 of the work bench 10.

Support means 14 for the two prior art embodiments generally includes a pair of support legs 15 that are configured and arranged at opposing ends of the track 12. The legs 15 of the '981 (FIG. 1) patent are pivotally connected to the track 12 while the legs 15 of the '365 patent (FIG. 2) are rotatably connected to the track 12 using a support bracket 17 and detent pins 19.

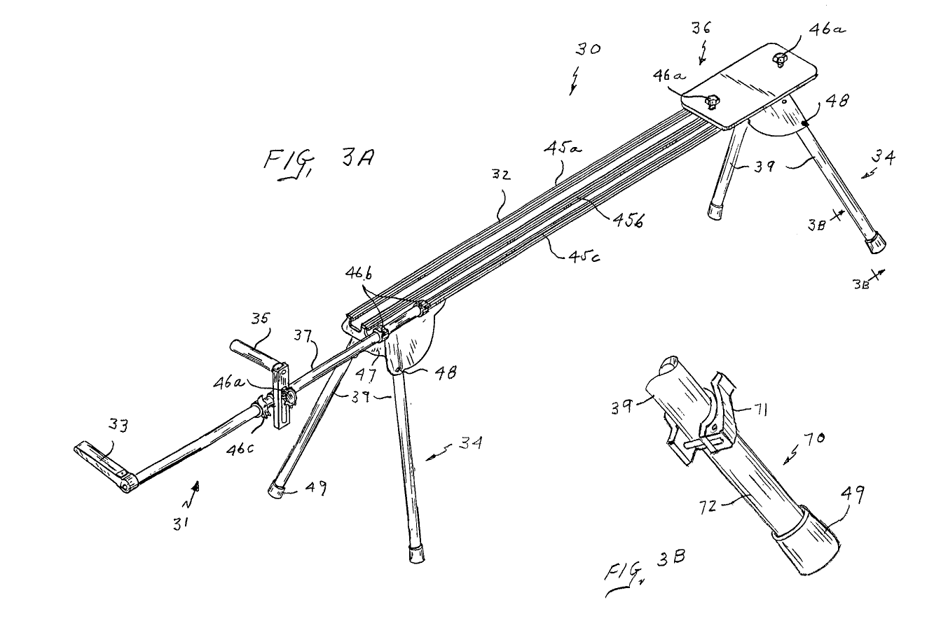

Referring now to FIG. 3, there is shown one aspect of the improvement to a work bench 30 in accordance with the present invention. Indeed, preferably the work bench 30 comprises an elongate track 32 and support means 34 similar to those found in the '981 and '365 patents in combination with an extension assembly 31 that is releasably, removably, and movably attached to the track 32 in a manner described below. More preferably, in order to work in confined areas, the length of the elongate track 32 between the pair of support legs 39 of the support means 34 is about 4 feet to about 6 feet.

In one aspect of the present invention, the track 32 is a lightweight, structural member designed to carry dead and live loads, e.g., its own weight, the weight of the accessories, and the weight of work pieces, and to withstand lateral and torsional loading applied thereto. In a preferred embodiment, the track 32 is fabricated from extruded aluminum, which is lightweight, strong, and can be easily manufactured. However, the track 32 can be manufactured from other materials, e.g., carbon and/or glass composites that exhibit similar strength and weight properties as aluminum.

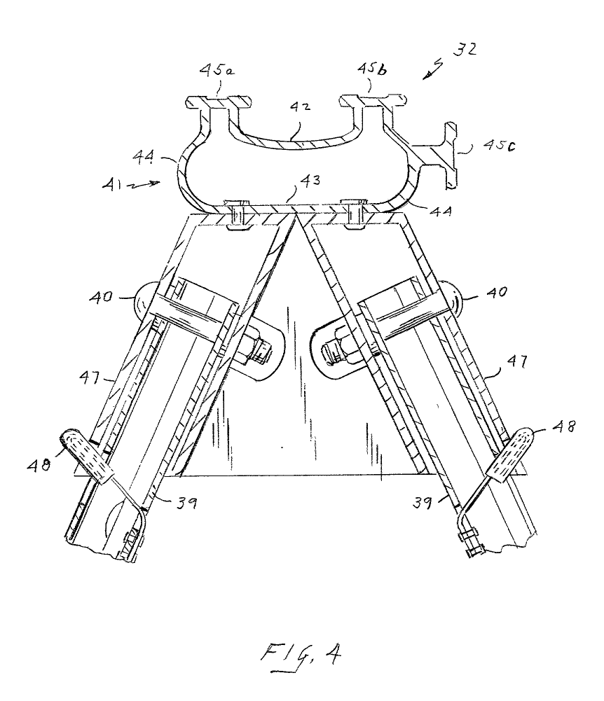

Referring now to FIG. 4, a preferred embodiment of the track 32 will be described. Preferably, the track 32 has an elongate tubular body 41. However, those skilled in the art will recognize that other structural members, e.g., channel members, I-beams or H-beams, and the like, can be used in design without violating the scope and spirit of this disclosure. More preferably, the track 32 comprises a thin wall element, substantially defining the entire outer perimeter of the tubular body 41, which perimeter is further defined to include a top wall 42, a bottom wall 43, and a pair of side walls 44.

According to one aspect of the present invention, the tubular body 41 of the work bench 30 includes a plurality of rail members 45a, 45b, and 45c for releasably and movably mounting one or more accessories to the track 32. Preferably, the tubular body 41 includes at least three rail members 45a, 45b, and 45c, which are integrally formed thereon and which, further, are configured and arranged to extend generally along the entire length of the elongate tubular body 41. More preferably, a first and a second rail member 45a and 45b are configured and arranged on the top wall 42 of the tubular body 41, substantially parallel to each other and a third rail member 45c is configured and arranged on one of the side walls 44 substantially vertical to the longitudinal axis of the track 32.

Each of the plurality of rail members 45a, 45b, and 45c is generally rectangular in cross-section for use in securely and releasably attaching one or more slidable locking devices 46a and 46b to one or more of the rail members 45a, 45b, and 45c. A first slidable locking device 46a, which is shown on the movable mounting assembly 36 of FIG. 3, is of a turn-knob-type that is described in great detail in the '981 patent and well known in the art. Second and third slidable locking devices 46b and 46c, which are shown on the extendable member 37 of the extension assembly 31, will be described in greater detail below.

Preferably, support means 34 for the present invention includes a pair of rotatable support legs 39, e.g., of tubular construction, disposed at either end of the simply supported track 32. Further, the pair of rotatable support legs 39 is configured and arranged so that each support leg 39 can be in an “open” position for supporting the track 32 above a surface, or in a “closed” position for ease in transporting and/or storing the work bench 30. A pair of connection brackets 47 for rotatably connecting the support legs 39 to the track 32, of a type that is described in detail in the '365 patent and well known to the art, is fixedly mounted, e.g., using rivets, fasteners, screw, bolts, and the like, to the undercarriage, or bottom wall 43, of the track 32 at opposing ends thereof. The upper portion of each support leg 39 is rotatably attached to one of the connection brackets 47, e.g., using a hinge pin 40. The lower portion of each support leg 39 can be provided with a protective cap 49, e.g., made of rubber, plastic, and the like, to prevent the support legs 39 from damaging the supporting surface and vice versa.

To maintain each support leg 39 in its open or closed position, the upper portion of each support leg 39 includes a biased detention pin 48 of a type that is described in detail in the '365 patent and well known to the art. Indeed, when the support leg 39 is in its open or closed position, the detention pin 48 extends through one of a plurality of openings (not shown) in the bracket 47. Biasing enables the detention pin 48 to maintain interference fit with the opening until the detention pin 48 is depressed again to release the bias. Accordingly, until depressed, the detention pins 48 secure the support legs 39 in their open position to support the track 32 or their closed position for ease of storing and transporting the work bench 30.

In another aspect of the present invention, slots for the detention pins 48 are configured and arranged to enable a craftsman to place the plurality of support legs 39 in their closed position for transporting and/or storing the work bench 30 using any leg folding sequence. For example, both of the legs 39 on the one side of the track 32 can be folded before both of the legs 39 on the other side of the track 32 or, one leg 39 from each side can be folded simultaneously, then the remaining legs 39 can be folded.

In an important aspect of the present invention, which constitutes a significant improvement over the prior art, the work bench 30 further comprises an extension assembly 31. Indeed, without an extension assembly 31, the track 32 can support accessories and work pieces in a confined space having a span of about 4 ft. to about 6 ft. between support means 34. With the extension assembly 31 securely attached to the track 32, the assembly 31 enables the craftsman to work with work pieces that are appreciable longer than the span between the support means 34. Indeed, in a preferred embodiment of the present invention, the extension assembly 31 can provide a span from the work stop assembly 33 to the more distant pair of support legs 39 between about 4 feet six inches and 9 feet 4 inches.

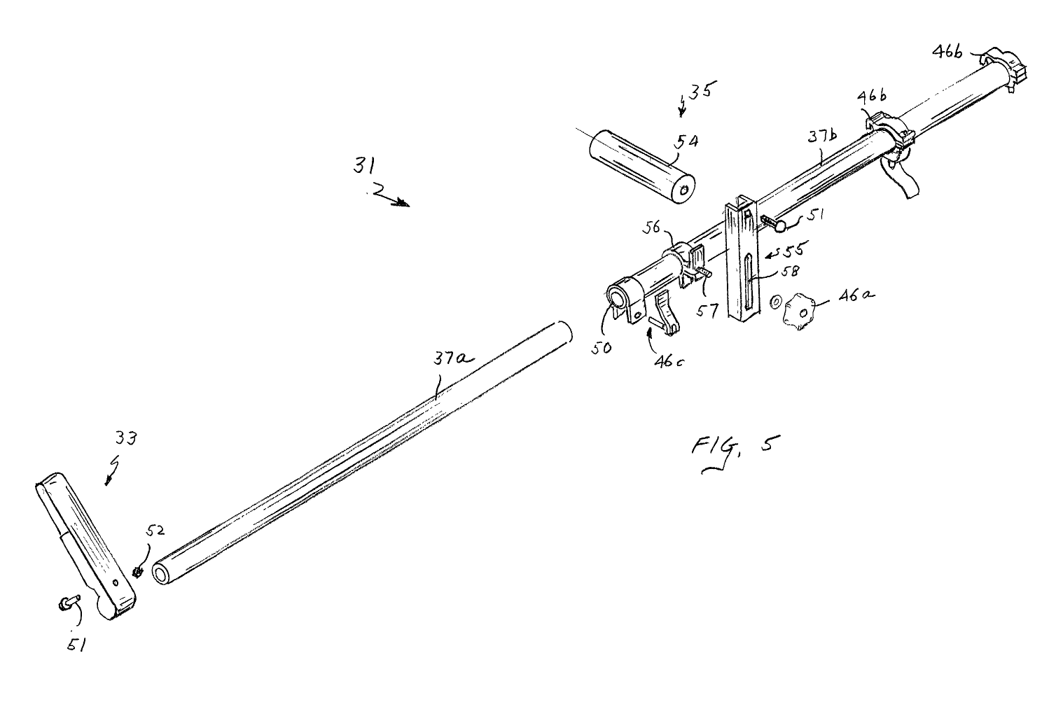

Referring to FIGS. 3 and 5, in a preferred embodiment of the extension assembly 31 includes one or more slidable locking devices 46b, which is/are disposed at a proximal end of an extendable member 37 for releasably and securely attaching the extendable member 37 to the third rail member 45c of the track 32; a work stop assembly 33, which is disposed at a distal end of the extendable member 37, for longitudinally holding and stabilizing the end of a work piece, e.g., to make a precision cut; and an adjustable work piece support assembly 35, which is disposed generally between the proximal and distal ends of the extendable member 37, for supporting work pieces above the elevation of the track 32 at the prescribed working elevation of the power tools. An extension assembly 31 having a work stop assembly 33 and a work piece support assembly 35 thereon enables craftsmen to work with relatively longer work pieces even when the available space for the support means 34 of the work bench 30 is limited to about 4 to 6 feet.

Several aspects of the extension assembly 31 will now be described. First, the centerpiece of the extension assembly 31 comprises an extendable member 37, having one or more slidable locking devices 46b at a proximal end, a work stop assembly 33 at a distal end, and an adjustable work piece support assembly 35 therebetween. In one embodiment of the extendable member 37, the extendable member 37 comprises a singular, tubular body, having, e.g., a circular cross-section. It should be noted, however, that a circular cross-section is merely illustrative for the purpose of describing the best mode of the invention. Indeed, the tubular body can have a polygonal, rectangular, square or triangular cross-section or can be a solid rod or bar without violating the scope and spirit of the invention.

More preferably, however, the extendable member 37 comprises a tubular body having an inner, slidably extendable concentric member 37a and an outer concentric member 37b. Accordingly, the inner concentric member 37a can be slidably moved relative to the outer concentric member 37b in a telescoping fashion. The outer concentric tube 37b can be releasably and securely attached to the third rail member 45c of the track 32 using at least two slidable locking devices 46b.

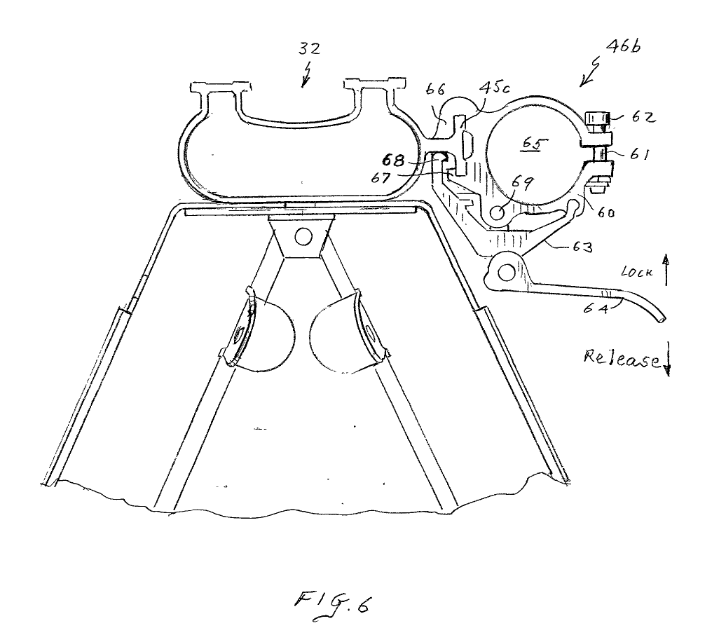

An aspect of one embodiment of the slidable locking device 46b is shown in FIG. 6. Preferably, one or more slidable locking devices 46b is/are provided at the proximal end of the extendable member 37 to releasably and securely attach, or mount, the extendable member 37 to, e.g., the third rail member 45c. More preferably, there are at least two slidable locking devices 46b at the proximal end of the extendable member 37.

The slidable locking device 46b comprises a body 60 that defines an annulus 65 into which, preferably, the extendable member 37 and, more preferably, the outer concentric member 37b can be inserted. A clamping means comprising, e.g., a tightening bolt 61 and nut 62, of a type that are well known to the art, can be used to securely and releasably attach the body 60 of the slidable locking device 46b to the extendable member 37. The body 60 includes mounting means that comprises a first and a second flange 66 and 67 for engaging the third rail member 45c as shown in FIG. 6. Moreover, a locking means 63 is rotatably attached to the body 60 by a pivot pin 69. Thus, in order to engage, or lock, the slidable locking device 46b onto the third rail member 45c, a locking handle 64 is rotated, e.g., in an upwards direction, exerting a force on the locking means 63 causing the locking flange 68 of the locking mean 63 to engage, e.g., the underside of the third rail member 45c. To release the slidable locking device 46b, the locking handle 64 is rotated, e.g., in a downward direction, causing the locking flange 68 to disengage from the third rail member 45c.

Referring again to FIG. 5, another aspect of the extension assembly 31 can be described. Indeed, there is shown further an inner, slidably extendable concentric member 37a that is configured and arranged to fit inside the annulus 50 of the outer concentric member 37b. A slidable clamping device 46c of a type that is well known to the art, e.g., a cam clamp-type locking device, can be used to releasably and securely attach the outer concentric member 37b to the inner concentric member 37a. This enable the inner concentric member 37a to telescope out to increase the overall working span of the work bench 30 from about 4 ft. 6 inches when the extension assembly 31 is fully contracted or not attached to about 9 feet 4 inches when the extension assembly 31 is fully extended.

The work stop assembly 33 will now be described. In one aspect of the present invention, the work stop assembly 33 is configured and arranged at a distal end of the extendable member 37, where it can be releasably and securely attached on to the extendable member 37. Preferably, the work stop assembly 33 is configured and arranged at one end of the inner, slidably extendable concentric member 37a. The work stop assembly 33 can be securely attached to the end of the inner, slidably extendable concentric member 37a using e.g., a tightening nut 51 and bolt 52.

The adjustable work piece support assembly 35 will now be described. The adjustable work piece support assembly 35 comprises a support arm 54 for supporting work pieces at the proper elevation of the power tool, an adjustable vertical support bracket 55 for adjusting the height of the support arm 54, and a slidable locking device 46a for securing the support arm 54 at a designated height.

The vertical support bracket 55 is releasably and adjustably attached to the extendable member 37 using a clamping means 56, e.g., a bolt 57 in combination with a slidable locking device 46a of a turn-knob type that is well known to the art. The bolt 57 of the clamping means 56 is configured and arranged to extend through a slot 58 in the vertical support bracket 55 and into a threaded hole (not shown) in the slidable locking device 46a. Thus, as the knob of the slidable locking device 46a is rotated, e.g., in a clockwise direction, the locking device 46a creates a tight interference fit between the locking device 46a, the vertical support bracket 55, and the extendable member 37. In this manner, the support arm 54 of the support assembly 35, which is releasably and securely attached to the vertical support bracket 55 using, e.g., a bolt 51, screw, fastener, and the like, can be raised and lowered as necessary to accommodate the working elevations of a plurality of power tools.

Although the present invention has been described in detail with reference to its preferred embodiments, it should be readily apparent to those skilled in the art that changes and modifications in form and details can be made without departing from the scope and spirit of this disclosure.

Indeed, the support means 34 of the work bench 30 can include one or more telescoping legs 70 that enable the work bench 30 to be used on uneven surfaces without the loss of stability. Referring to FIG. 3b, the telescoping leg 70 includes an inner, concentric leg 72 that is configured and arranged to fit inside of a conventional support leg 39. An adjustable cam-type clamping device 71 can be used to releasably and securely attach the conventional support leg 39 to the inner leg 72.

Moreover, in another embodiment of the present invention, a second extension assembly (not shown) having an adjustable work piece support assembly can be releasably and movably attached to the third rail member 45c at the opposite end of the work bench 30 to enable craftsmen to work with even longer work pieces. One aspect of the second extension assembly includes one or more slidable locking devices 46b for securing the second extension assembly to the track 32; inner and outer concentric member, and an adjustable work piece support assembly 35 that have been previously described herein.

What is claimed is

1. A portable work bench for working in areas of limited areal space comprising:
a track, having a structural body;
support means for supporting the track in an elevated position above a surface;
a sliding lock assembly further comprising:
a sliding lock member for mounting an accessory thereon, and
locking means for releasably and securely attaching and movably positioning said sliding lock member at any desired location on said track; and
an extension assembly further comprising:
an extendable member, having a distal and a proximal end,
locking means disposed and slidably attached at said proximal end of said extendable member for releasably and securely attaching and movably positioning said extendable member on said track,
a workstop assembly disposed and removably attached at said distal end of said extendable member, and
an adjustable work piece support assembly for adjustably raising, lowering, and supporting a work piece.

2. The portable work bench as recited in claim 1, wherein the track includes a plurality of rail members integrally attached to the structural body of said track.

3. The portable work bench as recited in claim 2, wherein the plurality of rail members includes a first and second rail member, wherein said first and second rail members are fixedly attached to a top wall portion of the structural body of the track; and one or more third rail members, wherein each of said one or more third rail members is fixedly attached to a side wall portion of said structural body of said track.

4. The portable work bench as recited in claim 1, wherein the support means comprises a first pair of legs rotatably and securely attached to the track at an end thereof and a second pair of legs rotatably and securely attached to said track at another end thereof.

5. The portable work bench as recited in claim 4, wherein each leg of the first and second pair of legs are rotatably and securely attached to a bottom wall of the structural body of the track by a connection plate and hinging means.

6. The portable work bench as recited in claim 4, wherein one or more of the a pair of legs is configured and arranged to be extendable to substantially level said work bench on uneven surfaces.

7. The portable work bench as recited in claim 1, wherein the sliding lock assembly is releasably attached and slidably mounted to at least one of a plurality of rail members so as to be movable and positionable at any location on the track.

8. The portable work bench as recited in claim 1, wherein the accessory mounted of the sliding lock member is at least one of a power saw, a miter saw, a router, a power drill, and a band saw.

9. The portable work bench as recited in claim 1, wherein said extendable member further comprises:
an inner, slidably extendable concentric member and
an outer concentric member, having an annulus.

10. The portable work bench as recited in claim 9, wherein the inner concentric member is disposed in the annulus of the outer concentric member so that said inner concentric member is slidably movable and positionable relative to said outer concentric member.

11. The portable work bench as recited in claim 10, wherein the outer concentric member is securely and releasably attached to the inner concentric member using a clamping means.

12. The portable work bench as recited in claim 11, wherein the clamping means comprises a cam clamp-type locking device.

13. The portable work bench as recited in claim 1, wherein the extension assembly is releasably attached to at least one of a plurality of rail members so as to be slidably movable and positionable at any location along the track.

14. The portable work bench as recited in claim 1, wherein the work piece support assembly further comprises:
a support arm for supporting the work piece;
an adjustable vertical support bracket for adjustably raising and lowering said work piece arm;
first locking means for releasably and securely attaching and slidably moving said support arm to said adjustable vertical support bracket at a desired elevation above the track; and
second locking means for releasably and securely attaching the said work piece support assembly at any location on the extendable member.

15. The portable work bench as recited in claim 14, wherein the second locking means of the work piece support assembly comprises a cam-type locking device

16. The portable work bench as recited in claim 1, wherein the work piece support assembly is slidably mounted between the distal and the proximal ends of the extendable member, wherein said work piece support assembly is configured and arranged so as to be slidably movable and positionable at any location along said extendable member.

17. The portable work bench as recited in claim 1, wherein the slidable locking means of the sliding lock assembly comprises at least one of a turn-knob-type locking device and a cam locking-type device.

18. The portable work bench as recited in claim 1, wherein the locking means of the extension assembly comprises a cam locking-type device.

19. The portable work bench as recited in claim 1, wherein the work bench further comprises a second extension assembly comprising:
an extendable member, having a distal and a proximal end,
locking means disposed and slidably attached at said proximal end of said extendable member for releasably and securely attaching and movably positioning said extendable member on said track; and
an adjustable work piece support assembly for adjustably raising, lowering, and supporting a work piece.

20. The portable work bench as recited in claim 19, wherein the extendable member further comprises:
an inner, slidably extendable concentric member and
an outer concentric member, having an annulus.

21. The portable work bench as recited in claim 20, wherein the inner concentric member is disposed in the annulus of the outer concentric member so that said inner concentric member is slidably movable and positionable relative to said outer concentric member.

22. The portable work bench as recited in claim 21, wherein the outer concentric member of the second extension assembly is securely and releasably attached to the inner concentric member using a clamping means.

23. The portable work bench as recited in claim 22, wherein the clamping means comprises a cam clamp-type locking device.

24. The portable work bench as recited in claim 19, wherein the work piece support assembly of the second extension assembly further comprises:
a support arm for supporting the work piece;
an adjustable vertical support bracket for adjustably raising and lowering said work piece arm;
first locking means for releasably and securely attaching and slidably moving said support arm to said adjustable vertical support bracket at a desired elevation above the track; and
second locking means for releasably and securely attaching the said work piece support assembly at any location on the extendable member.

25. The portable work bench as recited in claim 19, wherein the second extension assembly is releasably and securely attached to at least one of a plurality of rail members so as to be slidably movable and positionable at any location along the track.

26. The portable work bench as recited in claim 19, wherein the work piece support assembly of the second extension assembly is slidably mounted between the distal and the proximal ends of the extendable member, wherein said work piece support assembly is configured and arranged so as to be sidably movable and positionable at any location along said extendable member.
